(19) United States
(12) Patent Application Publication
(10) Pub. No.: US 2006/0109043 A1
(43) Pub. Date: May 25, 2006

(54) Pulse generator

(76) Inventors: Dominicus Martinus Wilhelmus Leenaerts, Eindhoven (NL); Gerard Van Der Weide, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/531,017

(22) PCT Filed: Sep. 19, 2003
(86) PCT No.: PCT/IB03/04170

§ 371 Date: Apr. 12, 2005

(30) Foreign Application Priority Data
Oct. 16, 2002 (EP) 02079276.8

(51) Int. Cl. G06F 1/04

(52) U.S. Cl. 327/291

(57) ABSTRACT

A pulse generator comprising a series coupling of delay elements (D1, D2, D3, D4, D5) every two consecutive delay elements (D1, D2, D3, D4, D5) being coupled at a plurality of coupling points (A1, A2, A3, A4), the series coupling of delay elements (D1, D2, D3, D4, D5) having a first end (A0) and a second end (A5) coupled to a first signal (y) and a second signal (x), respectively, the first and second signals (x, y) having a same frequency and being mutually phase-shifted, the pulse generator being characterized in that it further comprises a zero-crossing detector (3) coupled to two mutually different coupling points (A2, A3) for generating an output pulse (O) having a duration determined by a ratio between a number of delay elements between the two different coupling points and a total delay of the series coupling of delay elements.

The invention relates to a pulse generator comprising a series coupling of delay elements, every two consecutive delay elements being coupled in a plurality of coupling points, the series coupling of delay elements having a first end and a second end coupled to a first signal and to a second signal, respectively, the signals having a same frequency and being mutually phase-shifted.

Normally a pulse i.e. a binary signal, or a sinusoidal signal, is generated using a reference crystal oscillator and a voltage controlled oscillator (VCO). The crystal oscillator and the VCO are connected in a PLL configuration. When high-speed pulse is necessary, the VCO have to generate high frequency signals. Building a VCO beyond 5 GHz is not a simple task. The main problems are phase noise and tuning range. Hence, pulses having a period of less than 0.2 ns are difficult to be generated, certainly when the jitter needs are less than a few pico seconds. The amount of jitter in a PLL is related to the bandwidth of the loop filter included in the PLL. The larger the bandwidth, the lower the jitter. For stability reasons, the loop bandwidth must be a factor 10 lower than the reference clock. Thus a high reference clock frequency is helpful.

U.S. Pat. No. 5,838,178 describes a frequency multiplier comprising embodied in a phase-locked loop (PLL). The PLL comprises a plurality of delay elements that furnish successive phase-shifted signals to a logical adder made up by EXCLUSIVE OR (XOR) gates. It is observed that there are necessary at least three level of XOR gates, the total number of XOR gates being at least 7. When integrating on a single chip the gates increase the area used by the PLL and implicitly it's price. It is further observed that there are supplementary delays associated to the XOR gates making precise duration pulse generation hard to be realized. Furthermore, using only digital gates, the signals provided at their inputs have to be binary signals having high slope edges.

It is therefore an object of the present invention to obtain a high frequency pulse generator having a reduced price and a low jitter.

In accordance with the invention this is achieved in a device according to the first paragraph characterized in that it further comprises a zero-crossing detector coupled to two mutually different coupling points for generating an output pulse having a duration determined by a ratio between a number of delay elements between the two different coupling points and a total delay of the series coupling of delay elements. The total delay through the delay elements considering that to each delay element Di corresponds a respective delay di is

$$Delay = {\sum }_{i = 1}^{N} di .$$

A phase-shift φi corresponds to a respective delay di. Let us consider that the total phase-shift between the first signal and the second signal is Φ. Hence the phase-shift associated to a delay element Di is φi/Φ. It is convenient to relate these delays to a well-defined amplitude level of the signals and a convenient level is the zero voltage level, considering that the signals amplitudes are between + and − same voltage i.e. the signal is bipolar. If the signal is unipolar, it could be used a level corresponding to an average voltage between a maximum one and a minimum one.

In an embodiment of the invention an oscillator coupled to a phase-shifter generates the first signal and the second signal. A relative simple way to generate phase-shifted signals is a coupling between an oscillator and a phase-shifter. The phase-shifter provides a signal having a frequency substantially equal to the frequency of the signal generated by the oscillator and mutually phase-shifted. A value of the phase-shift determines the necessary number for the delay elements for generating a pulse having a specified duration. It is pointed out that whenever a quadrature oscillator is available, as in modern communication systems, the first and the second signals could be the in-phase and the quadrature signals generated by the oscillator. Hence, a further cost and complexity reductions are obtained.

In another embodiment of the invention the delay elements comprise equal-value resistor means. Resistor means are very suitable to be used as delay elements because they do not introduce additional phase-shifts and consequently no additional parasitic delays. Furthermore, using nowadays technology it is possible to integrate very high precision resistors and therefore to obtain substantially equal-value delays.

In another embodiment of the invention the zero-crossing detector is a latch. As it is well known, latches are bi-stable devices that are used in digital sequential circuit design. Whenever the first signal is bigger that zero the latch generates a logical 1 and when the second signal is bigger than zero the latch generates a logical zero. It is first observed that the pulse could be also generated using complementary input signals. Additionally, the output pulse could be also complementary to the above-mentioned situation. In fact there are possible multiple possible combinations for obtaining the output pulse using a latch, the combinations being obvious for a skilled person in the art.

The above and other features and advantages of the invention will be apparent from the following description of exemplary embodiments of the invention with reference to the following drawings, in which:

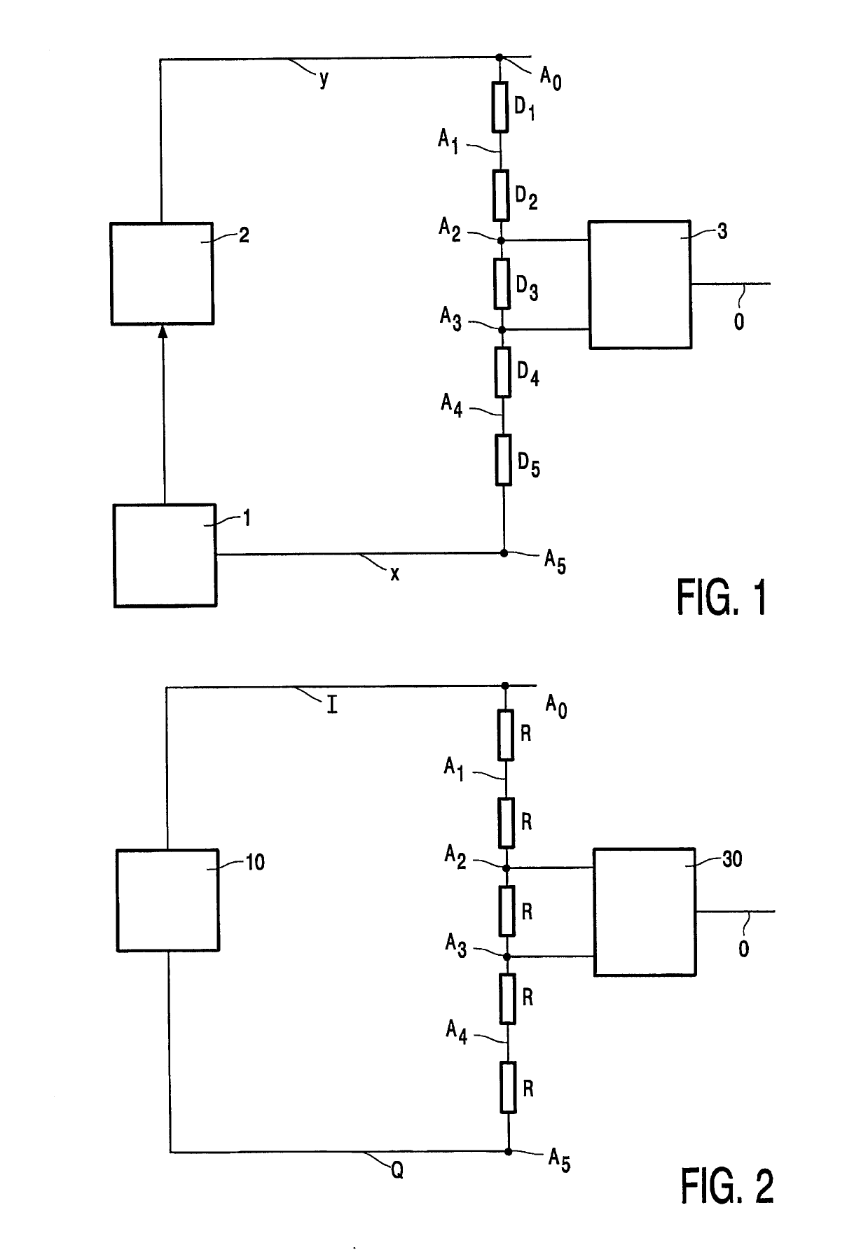

FIG. 1 depicts a pulse generator according to the invention,

FIG. 2 depicts an embodiment of the pulse generator using quadrature signals and resistors, and

FIG. 3 depicts the In-phase and Q-phase signals generated by a quadrature oscillator.

FIG. 1 depicts a pulse generator according to the invention. The pulse generator comprises a series coupling of delay elements D1, D2, D3, D4, D5. Every two consecutive delay elements D1, D2, D3, D4, D5 are coupled to each other in a plurality of coupling points A1, A2, A3, A4. The series coupling of delay elements D1, D2, D3, D4, D5 has a first end A0 and a second end A5 coupled to a first signal y and a second signal, respectively. The signals x, y have a same frequency and are mutually phase-shifted. The pulse generator further comprises a zero-crossing detector 3 coupled to two different coupling points A2, A3 and generating an output pulse 0 having a duration determined by a ratio between a number of delay elements between the two different coupling points and a total delay of the series coupling of delay elements. Considering that to each delay element Di corresponds a respective delay di, the total delay through the delay elements is

$$Delay = {\sum }_{i = 1}^{N} di .$$

A phase-shift φi corresponds to a respective delay di. Let us consider that the total phase-shift between the first signal and the second signal is Φ. Hence the phase-shift associated to a delay element Di is φi/Φ. It is convenient to relate these delays to a well-defined amplitude level of the signals and a convenient level is the zero voltage level, considering that the signals amplitudes are between + and − same voltage i.e. the signal is bipolar. If the signal is unipolar, it could be used a level corresponding to an average voltage between a maximum one and a minimum one. The signals x, y are generated by an oscillator 1 coupled to a phase shifter 2, respectively.

The mechanism of generation of relatively high frequency pulse is discussed using FIG. 2, which depicts an embodiment of the pulse generator using quadrature signals and resistors. Resistors are very suitable to be used as delay elements because they do not introduce additional phase-shifts and consequently no additional parasitic delays. Furthermore, using nowadays technology it is possible to integrate very high precision resistors and therefore to obtain substantially equal-value delays.

Furthermore let us consider that all the resistors have a substantially equal value and, therefore, they provide substantially equal delays. In addition to this we propose the following concept. Suppose we have a quadrature oscillator 10, generating a sinusoidal signal having a frequency equal to 1 GHz. For such frequency, relatively low phase noise can be obtained (−140 dBc at 1 MHz offset), the oscillator having a relatively large tuning range (2:1 or more). For a 1 GHz signal, the zero crossings of any of the sinusoidal output signals I and Q are separated by 0.5 ns. Considering the I signal as reference then the Q signal is 0.25 ns delayed compared to the signal I because the signals are in quadrature. Because the delay elements are equal valued, it results that the zero crossing at resistor connected between A0 and A1 is delayed by 0.05 ns compared to the I-signal and the zero crossing at resistor connected between A1 and A2 is delayed 0.1 ns. In FIG. 3 the I/Q signal and the intermediate signals are plotted. In general, for n identical resistors, we have at node j a delay time that equals 0.25 ns/n*j compared to the I-signal and the delay between to adjacent resistors is 0.05 ns or 0.25 ns/n in general for n resistors. We can use the zero crossing to drive a fast latch to generate the pulse. If the adjacent resistors are used, the pulse is 0.05 ns or 20 GHz, if the I and Q signals are sinusoidal signals of 1 GHz. In FIG. 2 a latch 30 is coupled to two consecutive connection points A2 and A3 between the resistors. Whenever the signal Q is bigger that zero the latch generates a logical 1 and when the signal I is bigger than zero the latch generates a logical zero. It is first observed that the pulse could be also generated using complementary input signals i.e. signals less than zero when bipolar signals are considered. Additionally, the output pulse could be also complementary to the above-mentioned situation. In fact there are possible multiple possible combinations for obtaining the output pulse using a latch, the combinations being obvious for a skilled person in the art.

From experiments it is known that the noise introduced by latch, up to a frequency of 10 GHz is much less than the quadrature oscillator 10 and therefore will not influence the zero crossings. Therefore, in this case it is possible to generate accurate 0.1 ns pulses from an oscillator 10 providing an output signal having a frequency of 1 GHz. It could be considered that the quadrature oscillator 10 that could be voltage controlled is locked in a Phase Locked Loop to keep the phase noise low and therefore the jitter of the output pulse. The resistors in FIG. 2 should match to each other. Currently, 14 bit accuracy is possible for a ladder of 18 resistors. However, in FIG. 2 only 5 resistors are used.

Let us suppose that the mismatch in the resistors causes an amplitude error:
ΔA=2Aπfₜ·Δt. (1)
In relation (1) it is assumed that the oscillator 10 generates a sinusoidal signal having an amplitude A and a frequency fᵢ. The amplitude error that is related to the mismatch, could be expressed as:

$$\frac{Δ A}{A} = {2}^{- B} \qquad ( 2 )$$

where B is number of bits in accuracy. Therefore, the delay error could be expressed as in relation (3)

$$Δ {t}_{max} = \frac{{2}^{- B}}{π {f}_{i}} \qquad ( 3 )$$

As an example, let us consider a precision of 10 bits of the resistors match and that the oscillator 10 generates a quadrature signal I, Q having 1 GHz frequency. It results that for the 100 ps pulse over the 5-resistor ladder, the frequency fᵢ is 10 GHz. Consequently, the time error due to mismatch is then found is 0.03 ps, which is better than the acceptable accuracy for the 100 ps pulse.

In principle this technique can be used where fast and accurate pulses are needed. A new principle for wireless communication is under development, named Ultra-wide band communication. In this concept, the information is in the time domain rather than in the frequency domain. A pulse of 10 Mz is generated and the data is modulated on this pulse in an exact time frame. To generate this time frame a pulse accuracy of 1 ps is needed, which can easily be obtained from the above example. However, this is not trivially obtained from a commercial crystal, which has normally an accuracy of 3-6 ps.

It is remarked that the scope of protection of the invention is not restricted to the embodiments described herein. Neither is the scope of protection of the invention restricted by the reference numerals in the claims. The word ‘comprising’ does not exclude other parts than those mentioned in the claims. The word ‘a(n)’ preceding an element does not exclude a plurality of those elements. Means forming part of the invention may both be implemented in the form of dedicated hardware or in the form of a programmed purpose processor. The invention resides in each new feature or combination of features.

1. A pulse generator comprising a series coupling of delay elements every two consecutive delay elements being coupled in a plurality of coupling points, the series coupling of delay elements having a first end and a second end coupled to a first signal and a second signal, respectively, the first and second signals having a same frequency and being mutually phase-shifted, the pulse generator being characterized in that it further comprises a zero-crossing detector coupled to two mutually different coupling points for generating an output pulse a duration determined by a ratio between a number of delay elements between the two different coupling points and a total delay of the series coupling of delay elements.

2. A pulse generator as claimed in claim 1, wherein the first signal and the second signal are generated by an oscillator coupled to a phase-shifter.

3. A pulse generator as claimed in claim 1, wherein the delay elements comprise equal-value resistor means.

4. A pulse generator as claimed in claim 3, wherein the first signal and the second signal are mutually shifted in quadrature signals.

5. A pulse generator as claimed in claim 4, wherein the mutually shifted in quadrature signals are generated by a quadrature oscillator.

6. A pulse generator as claimed in claim 1, wherein the zero-crossing detector is a latch.
